(19) United States
(12) Patent Application Publication
(10) Pub. No.: US 2025/0300793 A1
(43) Pub. Date: Sep. 25, 2025

(54) TRANSMISSION CONFIGURATION INDICATOR STATE UPDATE

(71) Applicant: Nokia Technologies Oy, Espoo (FI)

(72) Inventors: Matha DEGHEL, Montrouge (FR); Keeth Saliya Jayasinghe LADDU, Espoo (FI); Sami-Jukka HAKOLA, Kempele (FI)

(21) Appl. No.: 19/112,315

(22) PCT Filed: Aug. 24, 2023
(86) PCT No.: PCT/EP2023/073253

§ 371 Date: Mar. 17, 2025

(30) Foreign Application Priority Data
Sep. 29, 2022 (GB) 2214309.3

(51) Int. Cl. H04L 5/00; H04W 72/232

(52) U.S. Cl. CPC H04L 5/0098; H04W 72/232

(57) ABSTRACT

Embodiments of the present disclosure relate to devices, methods, apparatuses and computer readable storage media of Transmission Configuration Indicator (TCI) state update for multi-Transmission Reception Point (TRP) use cases. The method includes obtaining, at a terminal device and from a network node, information about applying at least one TCI state associated with a reference Component Carrier (CC), or Bandwidth Part (BWP) for at least one target CC or BWP; and determining one or more TCI states applied for the at least one target CC or BWP based on at least one of: the information, or a TRP mode for the reference CC or BWP; or a TRP mode for the at least one target CC or BWP.

### FIELD

Embodiments of the present disclosure generally relate to the field of telecommunication and in particular to devices, methods, apparatuses and computer readable storage media of Transmission Configuration Indicator (TCI) state update for multi-Transmission Reception Point (TRP) use cases.

### BACKGROUND

The 3rd Generation Partnership Project (3GPP) studies on enhancing multi-beam operation by introducing new functionalities to facilitate common TCI state update for multi-TRP scenarios. Furthermore, the 3GPP intends to extend unified TCI framework (beam indication framework for DL and UL) to all multi-TRP scenarios.

### SUMMARY

In general, example embodiments of the present disclosure provide a solution of TCI state update for multi-TRP use cases.

In a first aspect, there is provided an apparatus. The apparatus comprises at least one processor; and at least one memory storing instructions that, when executed by the at least one processor, cause the apparatus at least to obtain, from a network node, information about applying at least one TCI state associated with a reference Component Carrier (CC), or Bandwidth Part (BWP) for at least one target CC or BWP; and determine one or more TCI states applied for the at least one target CC or BWP based on at least one of the information, or a TRP mode for the reference CC or BWP or a TRP mode for the at least one target CC or BWP.

In a second aspect, there is provided an apparatus. The apparatus comprises at least one processor; and at least one memory storing instructions that, when executed by the at least one processor, cause the apparatus at least to transmit, to a terminal device, information about applying at least one TCI state associated with a reference CC or BWP for at least one target CC or BWP.

In a third aspect, there is provided a method. The method comprises obtaining, at a terminal device and from a network node, information about applying at least one TCI state associated with a reference CC or BWP for at least one target CC or BWP; and determining one or more TCI states applied for the at least one target CC or BWP based on at least one of the information, or a TRP mode for the reference CC or BWP or a TRP mode for the at least one target CC or BWP.

In a fourth aspect, there is provided a method. The method comprises transmitting, from a network node to a terminal device, information about applying at least one TCI state associated with a reference CC or BWP for at least one target CC or BWP.

In a fifth aspect, there is provided an apparatus comprising means for obtaining, from a network node, information about applying at least one TCI state associated with a reference CC or BWP for at least one target CC or BWP; and means for determining one or more TCI states applied for the at least one target CC or BWP based on at least one of the information, or a TRP mode for the reference CC or BWP or a TRP mode for the at least one target CC or BWP.

In a sixth aspect, there is provided an apparatus comprising means for transmitting, to a terminal device, information about applying at least one TCI state associated with a reference CC or BWP for at least one target CC or BWP.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of TCI state update for multi-TRP use cases according to some example embodiments of the present disclosure;

FIGS. 3A and 3B show examples of TCI state update for multi-TRP use cases according to some example embodiments of the present disclosure;

FIG. 4 shows a flowchart of an example method of TCI state update for multi-TRP use cases according to some example embodiments of the present disclosure;

FIG. 5 shows a flowchart of an example method of TCI state update for multi-TRP use cases according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network node” refers to a node in a communication network via which a terminal device accesses the network and receives services therefrom. The network node may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network node, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

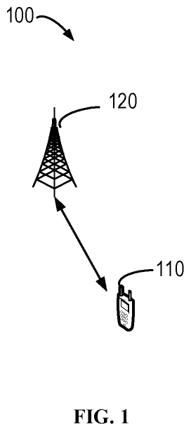

FIG. 1 shows an example communication network 100 in which embodiments of the present disclosure may be implemented. As shown in FIG. 1, the communication network 100 may comprise a terminal device 110. Hereinafter the terminal device 110 may also be referred to as a UE 110.

The communication network 100 may further comprise a network node 120. Hereinafter the network node 120 may also be referred to as a gNB 120. The terminal device 110 may communicate with the network node 120.

It is to be understood that the number of network nodes and terminal devices shown in FIG. 1 is given for the purpose of illustration without suggesting any limitations. The communication network 100 may include any suitable number of network nodes and terminal devices.

In some example embodiments, links from the network node 120 to the terminal device 110 may be referred to as a downlink (DL), while links from the terminal device 110 to the network node 120 may be referred to as an uplink (UL). In DL, the network node 120 is a transmitting (TX) device (or a transmitter) and the terminal device 110 is a receiving (RX) device (or receiver). In UL, the terminal device 110 is a TX device (or transmitter) and the network node 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Multi-TRP scenarios have been studied in release 17. In multi-TRP Uplink (UL) schemes, single Downlink Control Information (DCI) multi-TRP Time Division Multiplexing (TDM) Physical Uplink Control Channel (PUCCH) repetition operation in both frequency range 1 (FR1) and frequency range 2 (FR2) are specified.

For multi-TRP TDM PUCCH repetition operation in FR2, one PUCCH resource is used and two spatial relation info for a PUCCH resource are activated via Medium Access Control-Control Element (MAC-CE), while for multi-TRP TDM PUCCH repetition operation in FR1, one PUCCH resource is used and two power control parameters sets for a PUCCH resource are activated via (new) MAC CE.

Two multi-TRP TDM PUCCH repetition schemes supported, namely the inter-slot repetition scheme in which the PUCCH repetitions on a slot basis and the intra-slot repetition scheme in which the PUCCH repetitions on a sub-slot basis.

When only single-DCI based multi-TRP TDM Physical Uplink Shared Channel (PUSCH) repetition operation is supported, multi-TRP TDM PUSCH repetition scheme may be based on PUSCH repetition Type A and Type B discussed in release 15 and 16.

The multi-TRP TDM PUSCH repetition operation may be enabled at least using two Sounding Reference Signal (SRS) resource sets configured for both codebook-based mode and non-codebook-based mode. Two SRS resource sets may have the same number of SRS resources.

In release 17, the unified TCI framework has been introduced, which means that TCI states so far providing quasi-co-location (QCL) assumptions for the reception of Downlink (DL) signals and channels may be used also to provide spatial sources for the transmission of UL signals and channels.

The unified TCI framework defines the concept of indicated TCI state. The indicated TCI state can be joint DL and UL TCI state or separate DL and separate UL TCI states. The indicated TCI state provides QCL source (DL) and spatial source (UL) for the set of downlink signals and channels and for the set of uplink signals and channels, respectively. In release 17, there can be one indicated joint DL and UL or one indicated DL and one indicate UL TCI state for the UE.

The unified TCI framework may comprise the following functionalities in high level. For example, a common TCI state (which may also be called as the indicated TCI) for a set of signals and channels at a time. The TCI state may be a joint DL/UL TCI state or separate DL TCI state and separate UL TCI state, respectively. The set (or pool) of joint and/or separate TCI states may be configured by Radio Resource Control (RRC). The MAC may activate a number (e.g., 8) of joint and/or separate TCI states. Before the indication, the first activated TCI state may be the current indicated TCI state. The DCI may indicate one of the activated TCI states to be the indicated TCI state, which may also be considered as a common TCI state.

For the DCI-based TCI state indication, DCI format 1_1/1_2 with and without DL assignment may be used to carry the TCI state indication. This indication may be confirmed by UE using HARQ ACK. For the application time of the beam indication, the first slot may be at least X ms or Y symbols after the last symbol of the acknowledgment of the joint or separate DL/UL beam indication. The TCI field codepoint may be configured for both joint DL/UL or separate DL and UL cases. The TCI field codepoint for joint DL/UL case may refer to TCI state for both DL and UL, while the TCI field codepoint for the separate DL and UL case may refer to a pair of DL TCI state and UL TCI state, a DL TCI state and an UL TCI state.

The common TCI update may refer to the update of indicated TCI state. If a RRC-configured TCI state pool is absent in the Physical Downlink Shared Channel (PDSCH) configuration for each BWP/CC and replaced with a reference to the RRC-configured TCI state pool in a reference BWP/CC, the source Reference Signal (RS) of the indicated TCI-State may provide a RS for the QCL for Demodulation Reference Signal (DM-RS) of PDSCH, a DM-RS of Physical Downlink Control Channel (PDCCH) and a Channel state information-Reference Signal (CSI-RS) in the set of configured CCs, and a reference, if applicable, for determining UL TX spatial filter for dynamic-grant and configured-grant based PUSCH and SRS in the set of configured CCs.

If the RRC-configured TCI state pool is configured in the PDSCH configuration for each BWP/CC, the source RS in each CC, to provide a RS for the QCL for DM-RS of PDSCH, a DM-RS of PDCCH and a CSI-RS in the CC, and a reference, if applicable, for determining UL TX spatial filter for dynamic-grant and configured-grant based PUSCH and SRS in the CC, is associated to the source RS of the indicated TCI state.

As described above, an extension of the unified TCI framework for indication of multiple DL and UL TCI states may focus on multi-TRP use cases. Therefore, how the common TCI state update operation is to be defined in case for multi-TRP may need to be further discussed.

According to some example embodiments of the present disclosure, there is provided a solution for TCI state update for multi-TRP use cases. In this solution, the UE obtains an information (and/or a configuration) at least indicating that at least one TCI state associated with a reference CC or BWP for at least one target CC or BWP; this information essentially indicates, configures and/or enables the UE to determine whether and/or which TCI state(s), from TCI states associated with or corresponding to the reference CC or BWP, are applicable to the target CC or BWP. Based on at least one of the information or a TRP mode for the reference CC or BWP and/or the at least one target CC or BWP, the UE determines one or more TCI states applied for the at least one target CC or BWP. In this way, an efficient solution may be achieved to the common TCI state across CCs/BWPs considering the multi-TRP use cases without increasing the control overhead.

It is to be understood that the TRP mode used hereinafter may refer to a single TRP mode or a multi-TRP mode.

Example embodiments of the present disclosure will be described in detail below with reference to the accompanying drawings.

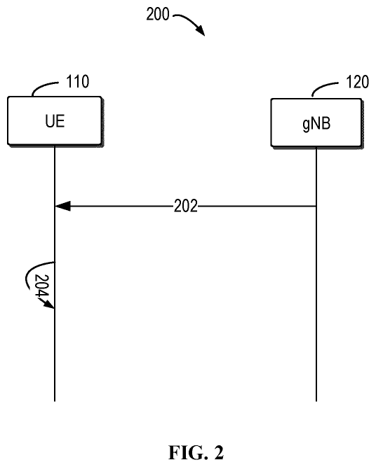

Reference is now made to FIG. 2, which shows a signaling chart 200 for communication according to some example embodiments of the present disclosure. As shown in FIG. 2, the signaling chart 200 involves a UE 110 and a gNB 120. For the purpose of discussion, reference is made to FIG. 1 to describe the signaling chart 200.

As shown in FIG. 2, the gNB 120 may transmit 202, to the UE 110, information (and/or a configuration) e.g., associated with or corresponding to TCI state(s). For example, the information (and/or the configuration) may indicate (and/or configure) whether at least one of two TCI states indicated for a reference CC or BWP (which may also be considered as a first CC or BWP or any other suitable/applicable CC or BWP) is to be applied for at least one target CC or BWP. The at least one target CC or BWP used hereinafter may also be referred to as the at least one given CC or BWP. It is to be understood that the reference CC or BWP may also be any CC or BWP in a set of CCs/or BWPs.

In some example embodiments, the at least one given CC or BWP and the reference CC or BWP may belong to the same CC or BWP set (list or group). It is to be understood that the terms CC or BWP in the present solution may also be replaced with cell.

In some example embodiments, the information associated with or corresponding to TCI state(s) may be configured or operated per CC or per CC subset. Alternatively or optionally, the information associated with or corresponding to TCI state(s) may also be configured or operated per physical channel, such as PDCCH, PDSCH, PUCCH or PUSCH. It is also possible that the information may also be configured or operated per reference signal, such as SRS or CSI-RS. As another option, the information may also be configured or operated per transmission direction, i.e., UL direction or DL direction.

In some example embodiments, the information associated with or corresponding to TCI state(s) may be transmitted to the UE 110 via a broadcast signalling, an RRC signalling, a MAC-CE or DCI. In some other example embodiments, the information may be at least partly replaced by or referred to as a configuration or a pre-configuration, based on which the UE may be configured to follow some rules/conditions in order to enable the UE determining which and/or whether TCI states, from TCI states corresponding to the reference CC or BWP, apply to at least one target CC or BWP.

After obtaining the information, the UE 110 may determine one or more TCI states for the at least one given CC/BWP based on at least one of the information or the TRP mode for the reference CC/BWP or the TRP mode for at least one given CC or BWP.

It is to be understood that the TRP mode used hereinafter may refer to a single TRP mode or a multi-TRP mode. The TRP mode applicable for a CC or BWP in the reference CC or BWP and/or at least one given CC/BWP may be based on pre-configured/pre-determined configuration. For example, the single-TRP mode is assumed to be configured or is determined in a CC or BWP if multi-TRP mode is not configured in the CC or BWP. It is also possible that the single-TRP mode is applicable in a CC/BWP if a single TCI state is indicated or applicable in the CC or BWP. It is also possible that the single-TRP mode is applicable in a CC/BWP if at least two CORESETPoolIndex(es) are not configured (or no CORESETPoolIndex is configured) in the CC or BWP.

Moreover, a multi-TRP mode is applicable in a CC/BWP if at least two TCI states are indicated or applicable in the CC or BWP. Further, a multi-TRP mode is applicable in a CC or BWP if at least one of an SDM scheme, namely multi-TRP TDM scheme, or simultaneous UL transmission scheme is configured or applicable in the CC or BWP. It is also possible that the multi-TRP mode is applicable in a CC/BWP if at least two CORESETPoolIndex(es) are configured in the CC or BWP.

In some example embodiments, if the UE 110 determines that two TCI states are indicated for the reference CC or BWP and the at least one given CC/BWP is configured to apply the two indicated TCI states, the UE 110 may determine that the two indicated TCI states are applied for the at least one given CC/BWP. In this case, an order of two TCI states for the reference CC/BWP may also indicated in the information. The UE 110 may apply the two indicated TCI states based on the order.

In some other example embodiments, if the UE 110 determines that two TCI states are indicated for the reference CC or BWP and the at least one given CC/BWP is configured to follow one indicated TCI state, the UE 110 may determine a TCI state to be applied for the at least one given CC/BWP from the two indicated TCI states, for example, based on an index or a ranking of a TCI state from the two indicated TCI states indicated in the information. For example, the information may indicate that the UE 110 may follow a TCI state with a highest or a lowest index of TCI state within the two indicated TCI state.

In some example embodiments, if the reference CC/BWP is configured with single-TRP or multi-TRP schemes and only one TCI state is indicated or applicable, the UE 110 may determine, based on at least one of the information or the TRP mode, that the indicated/applicable TCI is to be applied for the at least one given CC/BWP, regardless of whether the at least one given CC/BWP is configured with multi-TRP schemes. Hereinafter the single-TRP or multi-TRP schemes mentioned above may include DL/UL multi-TRP schemes such as single-DCI, multi-DCI and/or Frequency Division Multiplexing (FDM)/Spatial Division Multiplexing (SDM)/TDM and/or simultaneous UL transmissions.

As another option, if the UE is configured to consider, in addition to the one indicated TCI state, other TCI state as a further indicated/applicable TCI state for the at least one given CC/BWP, the further indicated/applicable TCI state may be the latest or earlier indicated/applicable TCI state. It is also possible that a default TCI state may be applied as the further indicated/applicable TCI state.

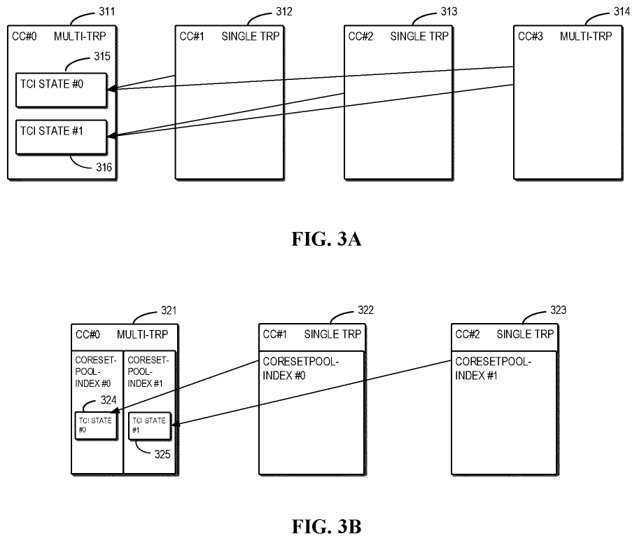

As shown in FIG. 3A, two TCI states, namely TCI state #0 and #1 are indicated for the reference CC 311 (i.e., CC #0), which is configured with multi-TRP, for the CC 312 (i.e., CC #1) and CC 313 (CC #2) configured with single TRP, if the CC 312 is configured to follow the first indicated TCI state in the reference CC, the TCI state #0 may be applied for the CC 312, while if the CC 313 is configured to follow the second indicated TCI state in the reference CC, the TCI state #1 may be applied for the CC 313. For the CC 314 (i.e., CC #3) configured with multi-TRP, if the CC 314 is configured to follow the first and the second indicated TCI states, the TCI state #0 and the TCI state #1 may be applied for the CC 314.

In some example embodiments, if the reference CC or BWP is configured with multi-TRP, for example, through the indication of at least two indices of Control Resource Set (CORESET) pools (which may be represented as CORESETPoolIndex), the UE 110 determines one or more TCI states to be applied for the at least one given CC/BWP based on the indicated TCI state(s) corresponding to at least one CORESETPoolIndex.

It is to be understood that the CORESETPoolIndex used hereinafter may also be replaced by TRP ID or Physical Cell ID (PCI) or CORESET group ID or any other suitable identifier.

In some example embodiments, if the at least one given CC or BWP is not configured with multi-TRP, which means that no CORESETPoolIndex is configured for the at least one given CC or BWP or a single CORESETPoolIndex is configured for the at least one given CC or BWP, the UE may assume that CORESETPoolIndex #0, or CORESETPoolIndex with the lowest index is configured for the at least one given CC/BWP. Alternatively, the UE 110 may be configured with a single CORESETPoolIndex in this case.

As one option, if the reference CC or BWP is configured with multi-TRP and at least one given CC or BWP is configured with single-TRP, the UE 110 may determine that the indicated TCI state applicable for one of at least two CORESETPoolIndex, for example, the indicated TCI state applicable for CORESETPoolIndex #0 or #1 for the reference CC or BWP may be used for the at least one given CC or BWP.

As another option, if the reference CC or BWP is configured with multi-TRP and at least one given CC or BWP is also configured with multi-TRP, the UE 110 may determine respective indicated TCI state corresponding to the at least two CORESETPoolIndex may be used for the at least one given CC or BWP. For example, the indicated TCI state corresponding to the CORESETPoolIndex #0 for the reference CC or BWP may be used for CORESETPoolIndex #0 for the at least one given CC or BWP and the indicated TCI state corresponding to the CORESETPoolIndex #1 for the reference CC or BWP may be used for CORESETPoolIndex #1 for the at least one given CC or BWP.

As shown in FIG. 3B, the reference CC 321 (i.e., CC #0) is configured with multi-TRP through CORESETPoolIndex #0 and #1, and a TCI state is corresponding to each CORESETPoolIndex. For example, TCI state #0 is corresponding to the CORESETPoolIndex #0 and TCI state #1 is corresponding to the CORESETPoolIndex #1. If the CC 322 (i.e., CC #1) configured with single TRP is configured to follow the indicated TCI state for CORESETPoolIndex #0 in the reference CC 321, the TCI state #0 may be applied for the CC 322. If the CC 323 (i.e., CC #2) configured with single TRP is configured to follow the indicated TCI state for CORESETPoolIndex #1 in the reference CC 321, the TCI state #1 may be applied for the CC 323.

In some example embodiments, a switching between multi-TRP and single-TRP, including a switching from multi-TRP to single-TRP or a switching from single-TRP to multi-TRP, for a given channel/signal/direction on the reference CC or BWP may occur dynamically. For example, the switching may occur through a configuration, an indication, or even through the number of indicated/applicable TCI state(s). In this situation, the switching may also be configured/specified to be also applied or not applied to the at least one given CC/BWP.

In some example embodiments, the indication of one or two TCI states, and/or any of the proposed operations above and below, for the reference CC or BWP may also include and/or be applicable to cross-carrier scheduling where the reference CC or BWP is the scheduling cell and the at least one given CC or BWP is the scheduled cell, or vice versa.

In this way, an efficient solution may be achieved to the common TCI state across CCs/BWPs considering the multi-TRP use cases without increasing the control overhead.

FIG. 4 shows a flowchart of an example method 400 of TCI state update for multi-TRP use cases according to some example embodiments of the present disclosure. The method 400 may be implemented at the terminal device 110 as shown in FIG. 1. For the purpose of discussion, the method 400 will be described with reference to FIG. 1.

At 410, the terminal device 110 obtains, from a network node, information about applying at least one TCI state associated with a reference CC or BWP for at least one target CC or BWP.

At 420, the terminal device determines one or more TCI states applied for the at least one target CC or BWP based on at least one of: the information, or a TRP mode for the reference CC or BWP; or a TRP mode for the at least one target CC or BWP.

In some example embodiments, the reference CC or BWP and the at least one target CC or BWP belong to a same CC or BWP set.

In some example embodiments, the information is obtained via at least one of a RRC signaling, a MAC-CE or DCI.

In some example embodiments, the information is configured per CC, per subset of CC, per physical channel, per RS or per transmission direction.

In some example embodiments, if two TCI states are indicated for the reference CC or BWP and the two TCI states are applicable for the at least one target CC or BWP, the terminal device may obtain, from the information, an order of the two TCI states and apply the two TCI states based on the order.

In some example embodiments, if two TCI states are indicated for the reference CC or BWP and only one indicated TCI state is applicable for the at least one target CC or BWP, the terminal device may determine a target TCI state applied for the at least one target CC or BWP based on an index or a ranking of one of the two TCI states indicated in the information.

In some example embodiments, if a single TCI state is indicated for the reference CC or BWP, the terminal device may determine that the single TCI state is applied for the at least one target CC or BWP.

In some example embodiments, if a further TCI state is allowed to be applied for the at least one target CC or BWP, the terminal device may determine that the further TCI state based on at least one of at least one of a latest TCI indicated state, an earlier indicated TCI state, or a default TCI state.

In some example embodiments, if the reference CC or BWP is configured with the multi-TRP mode through at least two CORESET pool indices, the terminal device may determine that at least one TCI state corresponding to the at least two CORESET pool indices is applied for the at least one target CC or BWP.

In some example embodiments, if the at least one target CC or BWP is not configured with the multi-TRP mode or is configured with the single TRP mode, the terminal device may determine that a CORESET pool index is configured for the at least one target CC or BWP, the CORESET pool index is a CORESET pool index of the at least two CORESET pool indices having a predefined index, or a CORESET pool index of the at least two CORESET pool indices having a lowest index.

In some example embodiments, if the at least one target CC or BWP is configured with a single-TRP mode, the terminal device may determine that the one or more TCI states comprise a TCI state corresponding to one of at least two CORESET pool indices.

In some example embodiments, if the at least one target CC or BWP is configured with the multi-TRP mode, the terminal device may determine that the one or more TCI states comprise a first TCI state corresponding to a first CORESET pool index in the at least two CORESET pool indices and a second TCI state corresponding to a second CORESET pool index in the at least two CORESET pool indices.

In some example embodiments, if a switching between the multi-TRP mode(s) and the single TRP mode, or a switching between two multi-TRP modes (such as between SDM and TDM, or SDM and SFN, or simultaneous UL transmissions and TDM, etc.) occurs at the reference CC or BWP, the terminal device may determine or may be configured (e.g. via RRC) that the switching is applied or not applied to the at least one target CC or BWP. The switching in the reference CC or BWP may be done based on some dynamic indication, e.g., via DCI or MAC CE, and/or based on some RRC configuration and/or based on some predefined rules.

In some example embodiments, the information (defined above) may indicate that the at least one TCI state associated with the reference CC or BWP is applicable for a cross-carrier scheduling, and wherein the reference CC or BWP is a scheduling cell while the at least one target CC or BWP is a scheduled cell.

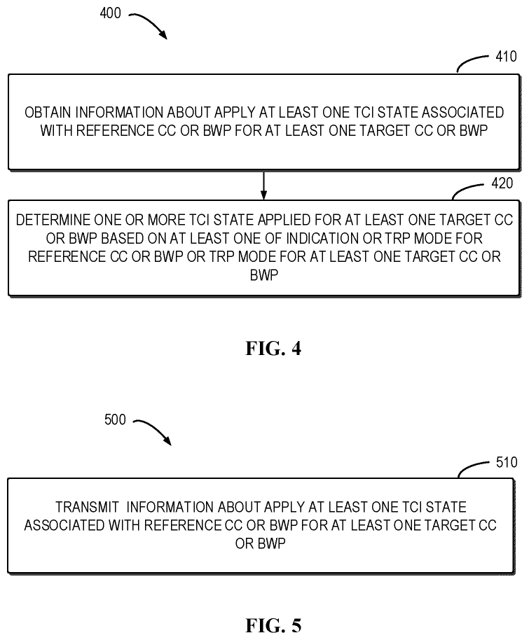

FIG. 5 shows a flowchart of an example method 500 of TCI state update for multi-TRP use cases according to some example embodiments of the present disclosure. The method 500 may be implemented at the network node 120 as shown in FIG. 1. For the purpose of discussion, the method 500 will be described with reference to FIG. 1.

At 510, the network node transmit, to a network node, information about applying at least one TCI state associated with a reference CC or BWP for at least one target CC or BWP.

In some example embodiments, the reference CC or BWP and the at least one target CC or BWP belong to a same CC or BWP set.

In some example embodiments, the information is transmitted via at least one of a RRC signaling, a MAC-CE or DCI.

In some example embodiments, the information is configured per CC, per subset of CC, per physical channel, per RS or per transmission direction.

In some example embodiments, an apparatus capable of performing the method 400 (for example, implemented at the terminal device 110) may include means for performing the respective steps of the method 400. The means may be implemented in any suitable form. For example, the means may be implemented in a circuitry or software module.

In some example embodiments, the apparatus comprises means for obtaining, from a network node, information about applying at least one TCI state associated with a reference CC or BWP is to be applied for at least one target CC or BWP; and means for determining one or more TCI states applied for the at least one target CC or BWP based on at least one of the information, or a TRP mode for the reference CC or BWP or a TRP mode for the at least one target CC or BWP.

In some example embodiments, the reference CC or BWP and the at least one target CC or BWP belong to a same CC or BWP set.

In some example embodiments, the means for obtaining the information may comprise means for obtaining the information via at least one of a RRC signaling, a MAC-CE or DCI.

In some example embodiments, the information is configured per CC, per subset of CC, per physical channel, per RS or per transmission direction.

In some example embodiments, the means for determining the one or more TCI states applied for the at least one target CC or BWP may comprise means for, in accordance with a determination that two TCI states are indicated for the reference CC or BWP and the two TCI states are applicable for the at least one target CC or BWP, obtaining, from the information, an order of the two TCI states and means for applying the two TCI states based on the order.

In some example embodiments, the means for determining the one or more TCI states applied for the at least one target CC or BWP may comprise means for, in accordance with a determination that two TCI states are indicated for the reference CC or BWP and only one indicated TCI state is applicable for the at least one target CC or BWP, determining a target TCI state applied for the at least one target CC or BWP based on an index or a ranking of one of the two TCI states indicated in the information.

In some example embodiments, the means for determining the one or more TCI states applied for the at least one target CC or BWP may comprise means for, in accordance with a determination that a single TCI state is indicated for the reference CC or BWP, determining that the single TCI state is applied for the at least one target CC or BWP.

In some example embodiments, the means for determining the one or more TCI states applied for the at least one target CC or BWP may comprise means for, in accordance with a determination that a further TCI state is allowed to be applied for the at least one target CC or BWP, determining that the further TCI state based on at least one of a latest TCI indicated state, an earlier indicated TCI state, or a default TCI state.

In some example embodiments, the means for determining the one or more TCI states applied for the at least one target CC or BWP may comprise means for, in accordance with a determination that the reference CC or BWP is configured with the multi-TRP mode through at least two indices of Control Resource Set, CORESET, pools, determining that at least one TCI state corresponding to the CORESET pools is applied for the at least one target CC or BWP.

In some example embodiments, the means for determining the one or more TCI states applied for the at least one target CC or BWP may comprise means for, in accordance with a determination that the at least one target CC or BWP is not configured with the multi-TRP mode or is configured with the single TRP mode, determining that a CORESET pool index is configured for the at least one target CC or BW, the CORESET pool index is one of a CORESET pool in the at least two CORESET pools having a predefined index, or a CORESET pool in the at least two CORESET pools having a lowest index.

In some example embodiments, the means for determining the one or more TCI states applied for the at least one target CC or BWP may comprise in accordance with a determination that the at least one target CC or BWP is configured with a single-TRP mode, determining that a TCI state corresponding to one of at least two CORESET pools is applied for the at least one target CC or BWP.

In some example embodiments, the means for determining the one or more TCI states applied for the at least one target CC or BWP may comprise means for, in accordance with a determination that the at least one target CC or BWP is configured with the multi-TRP mode, determining that a first TCI state corresponding to a first CORESET pool in the at least two CORESET pools and a second TCI state corresponding to a second CORESET pool in the at least two CORESET pools are applied for the at least one target CC or BWP.

In some example embodiments, the apparatus may further comprise means for, in accordance with a determination that a switching between the multi-TRP mode and the single TRP mode occurs at the reference CC or BWP, determining that the switching is applied or not applied to the at least one target CC or BWP.

In some example embodiments, the information indicates that the at least one TCI states associated with the reference CC or BWP is applicable for a cross-carrier scheduling, and wherein the reference CC or BWP is a scheduling cell while the at least one target CC or BWP is a scheduled cell.

In some example embodiments, an apparatus capable of performing the method 500 (for example, implemented at the network node 120) may include means for performing the respective steps of the method 500. The means may be implemented in any suitable form. For example, the means may be implemented in a circuitry or software module.

In some example embodiments, the apparatus comprises means for transmitting, to a terminal device, information about applying at least one TCI state associated with a reference CC or BWP for at least one target CC or BWP, a TRP mode comprising a single TRP mode or a multi-TRP mode is applicable for at least one of the following: the reference CC or BWP or the at least one target CC or BWP.

In some example embodiments, the reference CC or BWP and the at least one target CC or BWP belong to a same CC or BWP set.

In some example embodiments, the means for transmitting the information may comprise means for transmitting the information via at least one of a RRC signaling, a MAC-CE or DCI.

In some example embodiments, the information is configured per CC, per subset of CC, per physical channel, per RS or per transmission direction.

FIG. 6 is a simplified block diagram of a device 600 that is suitable for implementing example embodiments of the present disclosure. The device 600 may be provided to implement a communication device, for example, the UE 110 or the gNB 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

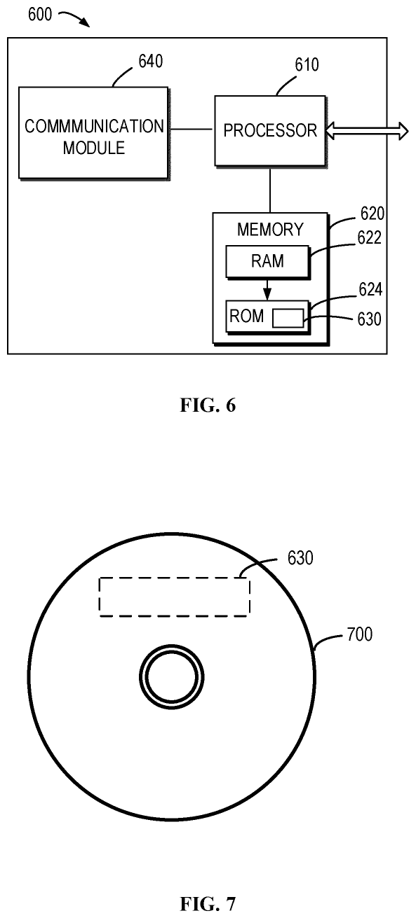

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-25. (canceled)

26. An apparatus comprising:
at least one processor; and
at least one memory storing instructions that, when executed by the at least one processor, cause the apparatus at least to:
obtain, from a network node, information about applying at least one Transmission Configuration Indicator, TCI, state associated with a reference Component Carrier, CC, or Bandwidth Part, BWP for at least one target CC or BWP; and
determine one or more TCI states applied for the at least one target CC or BWP based on at least one of the following:
the information, or
a Transmission Reception Point, TRP, mode for the reference CC or BWP, or
a TRP mode for the at least one target CC or BWP.

27. The apparatus of claim 26, wherein the reference CC or BWP and the at least one target CC or BWP belong to a same CC or BWP set.

28. The apparatus of claim 26, wherein the information is obtained via at least one of the following:
a Radio Resource Control, RRC, signaling, or
a medium access control-control element, MAC-CE, or
Downlink Control Information, DCI.

29. The apparatus of claim 26, wherein the information is provided at least one of the following:
per CC, or
per subset of CC, or
per physical channel, or
per reference signal, or
per transmission direction.

30. The apparatus of claim 26, wherein the at least one TCI state comprises two TCI states indicated for the reference CC or BWP and the information comprises an order of the two TCI states, and wherein the apparatus is further caused to:
determine that the two TCI states are applicable for the at least one target CC or BWP; and
based on the determination, determine that the one or more TCI states comprise the two TCI states, wherein the two TCI states are to be applied based on the order.

31. The apparatus of claim 26, wherein the at least one TCI state comprises two TCI states indicated for the reference CC or BWP and the information comprises an index or a ranking of one of the two TCI states, and wherein the apparatus is further caused to:
determine that a TCI state selected from the two TCI states is applicable for the at least one target CC or BWP; and
based on the determination, determine that the one or more TCI states comprise the TCI state, wherein the TCI state is selected based on the index or the ranking.

32. The apparatus of claim 26, wherein the at least one TCI state comprises a single TCI state, and wherein the apparatus is further caused to:
determine that the one or more TCI states comprise the single TCI state.

33. The apparatus of claim 31, wherein a further TCI state is applicable for the at least one target CC or BWP, and wherein the apparatus is further caused to:
determine that the one or more TCI states comprise the further TCI state, wherein the further TCI state is based on at least one of the following:
a latest indicated TCI state, or
an earlier indicated TCI state, or
a default TCI state.

34. The apparatus of claim 26, wherein the reference CC or BWP is configured with a multi-TRP mode through at least two Control Resource Set, CORESET, pool indices, and wherein the apparatus is further caused to:
determine that the one or more TCI states comprise at least one TCI state corresponding to the at least two CORESET pool indices is applied for the at least one target CC or BWP.

35. The apparatus of claim 34, wherein at least one target CC or BWP is not configured with a multi-TRP mode or is configured with a single TRP mode, wherein the apparatus is further caused to:
determine that a CORESET pool index is configured for the at least one target CC or BWP, the CORESET pool index is one of the following:
a CORESET pool index of the at least two CORESET pool indices having a predefined index, or
a CORESET pool index of the at least two CORESET pool indices having a lowest index.

36. The apparatus of claim 34, wherein the at least one target CC or BWP is configured with a single-TRP mode, and wherein the apparatus is further caused to:
determine that the one or more TCI states comprise a TCI state corresponding to one of at least two CORESET pool indices.

37. The apparatus of claim 34, wherein the at least one target CC or BWP is configured with a multi-TRP mode wherein the apparatus is further caused to:
determine that the one or more TCI states comprise a first TCI state corresponding to a first CORESET pool index in the at least two CORESET pool indices and a second TCI state corresponding to a second CORESET pool index in the at least two CORESET pool indices.

38. The apparatus of claim 26, wherein the apparatus is caused to:
determine that a switching between a multi-TRP mode and a single TRP mode occurs at the reference CC or BWP, determine that the switching is applied or not applied to the at least one target CC or BWP.

39. The apparatus of claim 26, wherein the information indicates that the at least one TCI state associated with the reference CC or BWP is applicable for a cross-carrier scheduling, and wherein the reference CC or BWP is a scheduling cell while the at least one target CC or BWP is a scheduled cell.

40. The apparatus of claim 26, wherein the apparatus comprises a terminal device.

41. An apparatus comprising:
at least one processor; and
at least one memory storing instructions that, when executed by the at least one processor, cause the apparatus at least to:
transmit, to a terminal device, information about applying at least one Transmission Configuration Indicator, TCI, state associated with a reference Component Carrier, CC, or Bandwidth Part, BWP for at least one target CC or BWP.

42. The apparatus of claim 41, wherein the reference CC or BWP and the at least one target CC or BWP belong to a same CC or BWP set.

43. The apparatus of claim 41, wherein the information is transmitted via at least one of the following:
a Radio Resource Control, RRC, signaling, or
a medium access control-control element, MAC-CE, or
Downlink Control Information, DCI.

44. The apparatus of claim 41, wherein the information is provided at least one of the following:
per CC, or
per subset of CC, or
per physical channel, or
per reference signal, or
per transmission direction.

45. An apparatus comprising:
means for obtaining, from a network node, information about applying at least one Transmission Configuration Indicator, TCI, state associated with a reference Component Carrier, CC, or Bandwidth Part, BWP for at least one target CC or BWP; and
means for determining one or more TCI states applied for the at least one target CC or BWP based on at least one of the following:
the information, or
a Transmission Reception Point, TRP, mode for the reference CC or BWP, or
a TRP mode for the at least one target CC or BWP.
